(19) United States
(12) Patent Application Publication
(10) Pub. No.: US 2012/0075075 A1
(43) Pub. Date: Mar. 29, 2012

(54) LABEL ANTI-COLLISION METHOD AND SYSTEM

(75) Inventors: Jiang Du, Guangdong (CN); Li Wang, Guangdong (CN); Yongzhi Zhang, Guangdong (CN)

(73) Assignee: ZTE CORPORATION, Shenzhen City, Guangdong (CN)

(21) Appl. No.: 13/375,540

(22) PCT Filed: Dec. 28, 2009
(86) PCT No.: PCT/CN09/76150

§ 371 Date: Dec. 1, 2011

(30) Foreign Application Priority Data
Jun. 12, 2009 (CN) 200910107964.5

(51) Int. Cl. G06K 7/01

(52) U.S. Cl. 340/10.2

(57) ABSTRACT

A label anti-collision method is disclosed, which is applied in a radio frequency identification system including a reader and labels. When the labels enter into an arbitration process, the reader sends the predetermined number of labels to the labels; the reader sends start counting instruction; after a label receives the start counting instruction, the label initializes its own information, and according to the predetermined number of the labels, selects a random number as an initial value of a counter and enters into the arbitration process. A label anti-collision system is also disclosed. With the method and the system, all the labels are hashed at the beginning of arbitrating with the Binary Tree method so as to reduce the probability of the collisions and improve the arbitration efficiency.

### TECHNICAL FIELD

The present invention relates to the field of wireless communication, and more particularly, to a label anti-collision method in the field of radio frequency identification (RFID).

### BACKGROUND OF THE RELATED ART

In practical RFID applications, there are many cases that one reader corresponds to a plurality of electronic labels in a RF field. When the reader counts a plurality of electronic labels simultaneously, there is channel contention and a collision will be occurred, thus the electronic labels cannot correctly send information to the reader. Therefore, a certain mechanism is needed to avoid or reduce collisions.

In the existing RFID international standard ISO 18000-6, class A and class C apply a time slot ALOHA algorithm, while class B uses a Binary Tree algorithm to solve the collision problem. Both the time slot ALOHA and the Binary Tree are based on a method of time division multiple access.

The time slot ALOHA algorithm divides the time into several discrete time slots, requires that the labels randomly select one time slot to send data at the boundary of the time slot. In the ISO 18000-6 class A and class C protocol, the process of using the time slot ALOHA algorithm for anti-collision is that: at the beginning of each arbitration process, the reader notifies all the labels of an optional time slot range, and the label randomly selects a time slot to reply, the labels might send successfully or completely collide, and if a collision occurs, a new time slot will be re-selected and data will be sent, until all the labels send successfully.

The basic idea of the Binary Tree is to split the labels under the collision into left and right subsets 0 and 1; first query the subset 0; if there is no collision, then correctly identify the labels; if there are collisions, further split the subset 0 into two subsets 00 and 01; and the rest may be deduced by analogy, until all the labels in the subset 0 are identified, then query the subset 1 according to these steps. The Binary Tree algorithm is shown as FIG. 1.

FIG. 1 is a flow chart of arbitrating with the existing Binary Tree algorithm, and the specific process is as follows:

S101, start;

S102, the reader selects the labels in an effective RF field area;

S103, the reader sends select instruction, after all the labels receive the instructions, the labels perform to match a condition, and those labels meeting the condition enter into the arbitration process; and the reader sends start counting instruction, and at the same time starts to receive signals from the labels in the stated time slot;

S104, after the labels receive the start counting instruction, the labels initialize their own information, counters are set to 0, and the branches whose counter values are 0 respond to the reader;

S105, judge whether the reader correctly receives response information from the labels or there is no response information from the labels or response information is collision error information; if it is the first one or the second one, proceed to S106, and if it is the third one, proceed to S108;

S106, the reader sends success acknowledgement instructions to the labels, and enters into the next time slot to receive;

S107, when the labels receive the success acknowledgement instructions, those labels whose IDs (label identifications) conform to success command parameters (the labels that correctly send the response information) leave the arbitration process after responding with acknowledgement successfully and do not respond any instruction related to the arbitration any more, while for those labels whose IDs do not conform to the success command parameters (i.e., the labels whose counter values are not 0), the counter values are subtracted by 1, and the labels whose counter values are 0 respond to the reader, proceed to S110;

if the response information from the labels is not received, there is no label to acknowledge at this time, thus the counter values of all the labels are subtracted by 1;

S108, if the reader receives the collision error response information from the labels within the stated time slot, the reader considers that a plurality of labels respond and the collisions occur, thus the reader sends failure acknowledgement instructions to the labels, and enters into the next time slot to receive;

S109, when the labels receive the failure acknowledgement instructions, the labels whose counter values are 0 perform to split and a random number generator is started up, and the labels modify the counter values according to the generated random number; and for other labels (the labels whose counter values are not 0), counter values are added by 1, and then the labels whose counter values are 0 respond to the reader, proceed to S110;

S110, judge whether the arbitration process ends in accordance with an ending condition, if ending, exit the arbitration process, otherwise, go back to step S105 to count continuously;

S111, end the flow.

From the description of the Binary Tree anti-collision process, it can be seen that the Binary Tree method always binary splits at the left side of the tree, that is, near the labels of 0, the advantage of this method is that in the entire label arbitration process, the counter values of the labels do not change greatly, thus reducing empty time slots and improving the entire arbitration efficiency.

However, in the arbitration process, the Binary Tree method will result in a large number of collisions at the beginning of arbitrating, this is because the counter values of all the labels are starting from 0, and if the number of labels is large, the collisions are a lot at the beginning of arbitration, which reduces the arbitration efficiency.

### Content of the Invention

In order to solve the above-mentioned technical problem, the present invention provides a label anti-collision method and system, and the method and system are applied in a radio frequency identification system to solve the problem that the counters of the labels are relatively concentrated when the labels start to count in the radio frequency identification system.

A label anti-collision method is applied in a radio frequency identification system comprising labels and a reader, and when the labels enter into an arbitration process, the method comprises:

the reader sending the predetermined number of labels to the labels and further sending start counting instruction;

after a label receives the start counting instruction, the label initializing its own information, according to the predetermined number of labels selecting a random number as an initial value of a counter and entering into the arbitration process.

Before the label enters into the arbitration process, the method comprises:

the reader selecting labels in an effective radio frequency field area;

the reader sending select instruction, and after the labels receive the select instruction, the labels performing a condition matching, and when meeting the condition the labels entering into the arbitration process.

The arbitration process comprises:

responding the information of the labels whose counter values are 0 to the reader;

the reader receiving the information of the labels;

if the reader receives a correct response information from a label or there is no response information within a stated time slot, the reader sending a success acknowledgement instruction to the label; and if the reader receives a collision error information within the stated time slot, the reader considering that a collision happens because a plurality of labels respond, and then sending failure acknowledgement instructions to the labels.

When the labels receive the success acknowledgement instructions, those labels whose label identifications conform to success command parameters comprising in the success acknowledgement instructions leave the arbitration process after further responding successfully; and for those labels whose label identifications do not conform to the success command parameters, the counter values of those labels are further subtracted by 1, and then the labels whose counter values are 0 further respond to the reader.

When the labels receive the failure acknowledgement instructions, those labels whose counter values are 0 further perform to split and a random number generator is started up, and the counter values are modified according to generated random numbers; and the labels whose counter values are not 0 further add the counter values by 1, while the labels whose counter values are 0 further respond to the reader.

A label anti-collision system comprises a reader and labels; wherein,

the reader is adapted to predetermine the number of labels, send the number of the labels to the labels, and send start counting instruction;

each of the labels is adapted to initialize information of the label itself after receiving the start counting instruction, select a random number as an initial value of a counter according to the predetermined number of the labels and enter into a arbitration process.

The system further comprises:

the reader is further adapted to select labels in an effective radio frequency field area and send select instruction before the labels enter into the arbitration process;

the labels are further adapted to perform a condition matching after receiving the select instruction, and the labels meeting the condition enter into the arbitration process.

The labels are further adapted to respond the reader with the information of the labels whose counter values are 0;

the reader is further adapted to receive the information of the labels within a stated time slot; and if the reader receives a correct response information from a label or there is no response information within the stated time slot, send a success acknowledgement instruction to the label, and if the reader receives a collision error information within the stated time slot, consider that a collision happens because a plurality of labels respond, and send failure acknowledgement instructions to the labels.

The labels are further adapted that:

when receiving the success acknowledgement instructions, those labels whose label identifications conform to success command parameters comprising in the success acknowledgement instructions leave the arbitration process after responding successfully; and for those labels whose label identification do not conform to the success command parameters, the counter values of those labels are subtracted by 1, and the labels whose counter values are 0 respond to the reader.

The labels are further adapted that:

when the labels receive the failure acknowledgement instructions, those labels whose counter values are 0 perform to split and a random number generator is started up, and the counter values are modified according to generated random numbers; and the labels whose counter values are not 0 add the counter values by 1, while the labels whose counter values are 0 respond to the reader.

With the technical scheme of the present invention, all the labels are hashed at the beginning of arbitration with the Binary Tree method, which reduces the probability of collisions and improves the arbitration efficiency.

### BRIEF DESCRIPTION OF DRAWINGS

FIG. 1 is a flow chart of arbitrating with an existing Binary Tree;

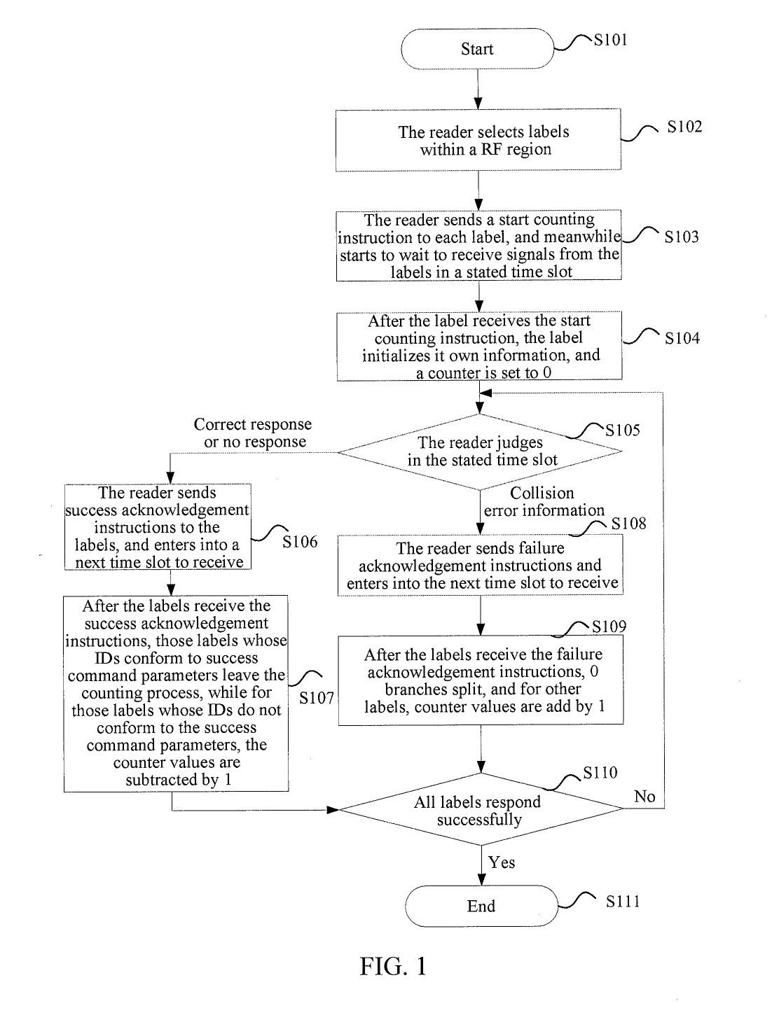

FIG. 2 is a flow chart of arbitrating in accordance with the present invention;

FIG. 3 is a schematic diagram of a Binary Tree arbitrating labels;

FIG. 4 is a schematic diagram of arbitrating after applying a method of the present invention.

### PREFERRED EMBODIMENTS OF THE PRESENT INVENTION

In the following, the embodiments of the present invention are described in detail in combination with the accompanying drawings.

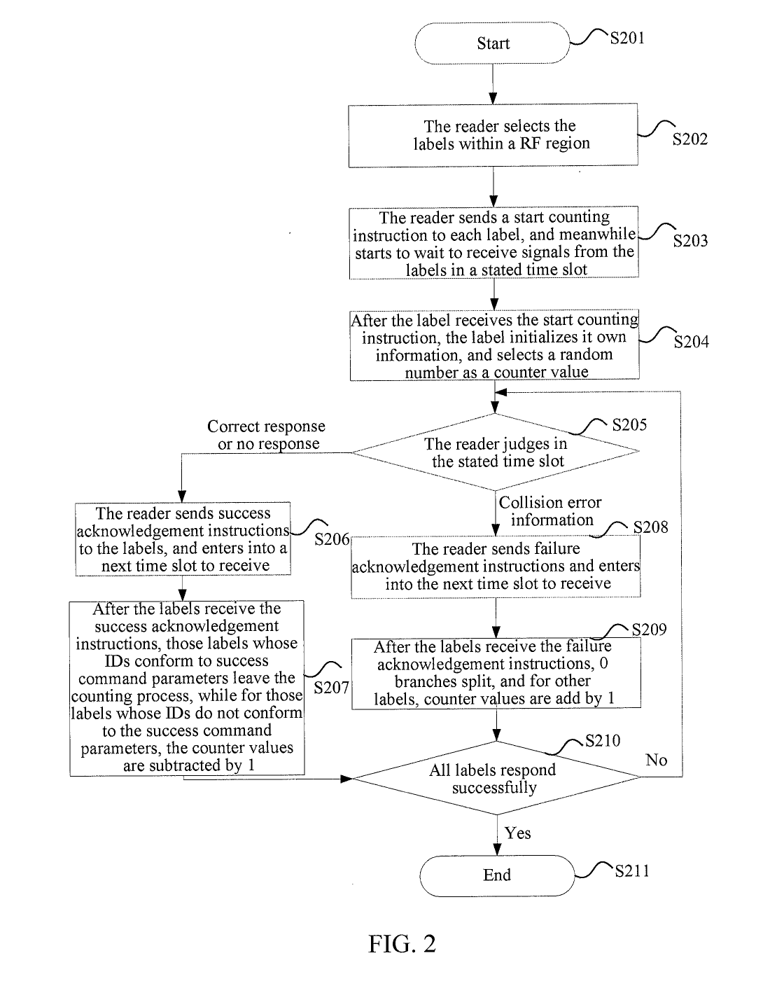

FIG. 2 is a flow chart of a arbitration algorithm after applying the present invention, the specific process is as follows:

S201, start;

S202, the reader selects the labels in the effective RF field area;

S203, the reader sends the select instruction, after all the labels receive the instruction, the labels perform to match a condition, and those labels meeting the condition enter into the arbitration process; and meanwhile, the reader sends the initial number of the labels to the labels via the select instruction;

the reader sends the start counting instruction, and meanwhile, receives the signals from the labels within the stated time slot;

S204, after the labels receive the start counting instruction, the labels initialize their own information and select a random number as an initial value of each counter in the optional range notified by the reader, and the branches whose counter values are 0 respond to the reader;

S205, judge whether the reader correctly receives the response information from the labels or there is no response information from the labels or the response information is collision error information; if it is the first one or the second one, proceed to S206, and if it is the third one, proceed to S208;

S206, the reader sends success acknowledgement instructions to the labels, and enters into the next time slot to receive;

S207, when the labels receive the success acknowledgement instructions, those labels whose IDs (label identifications) conform to the success command parameters (the labels that correctly send the response information) leave the arbitration process after responding the acknowledgement successfully and do not respond any instruction related to the arbitration any more, while for those labels whose IDs do not conform to the success command parameters (i.e., labels whose counter values are not 0), the counter values are subtracted by 1, and the labels whose counter values are 0 respond to the reader, proceed to S210;

if the response information from the labels is not received, there is no label to acknowledge at this time, thus the counter values of all the labels are subtracted by 1;

S208, if the reader receives the collision error response information from the labels within the stated time slot, the reader considers that a plurality of labels respond and the collisions occur, thus the reader sends failure acknowledgement instructions to the labels, and enters into the next time slot to receive;

S209, when the labels receive the failure acknowledgement instructions, the labels whose counter values are 0 perform to split and a random number generator is started up, and the labels modify the counter values according to the generated random number. For other labels (the labels whose counter values are not 0), counter values are added by 1, and then the labels whose counter values are 0 respond to the reader, proceed to S110;

S210, judge whether the arbitration process ends in accordance with an ending condition, if ending, exit the arbitration process, otherwise, go back to step 4 to count continuously;

S211, end the flow.

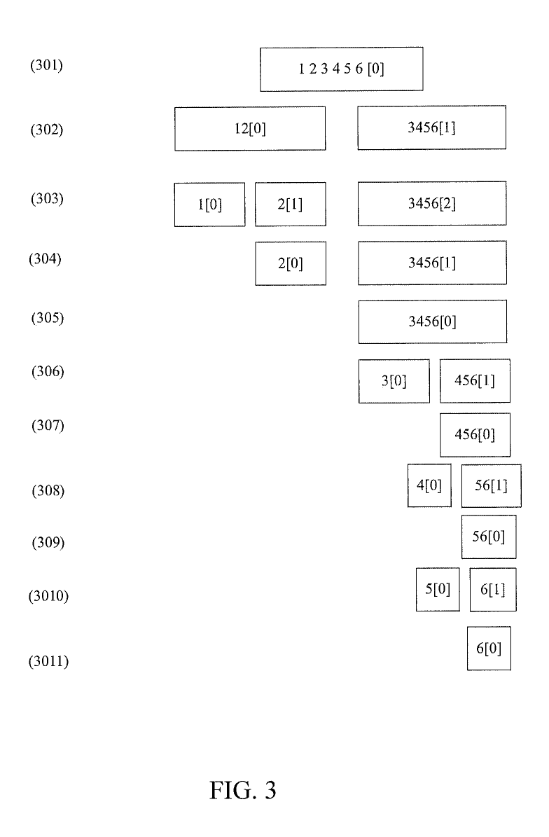

FIG. 3 is a schematic diagram of the label arbitration with the Binary Tree in a theoretical case, and a brief description of the arbitration process is:

(301) initialization, where the counter values of all the labels are 0 and the responses collide with each other;

(302) counter 001111, where the collisions occur;

(303) counter 012222, normal counting;

(304) counter 01111, normal counting

(305) counter 0000, where the collisions occur;

(306) counter 0111, normal counting;

(307) counter 000, where collisions occur;

(308) counter 011, normal counting;

(309) counter 00, where the collision occurs;

(3010) counter 01, normal counting;

(3011) counter 0, normal counting, where the arbitration process ends.

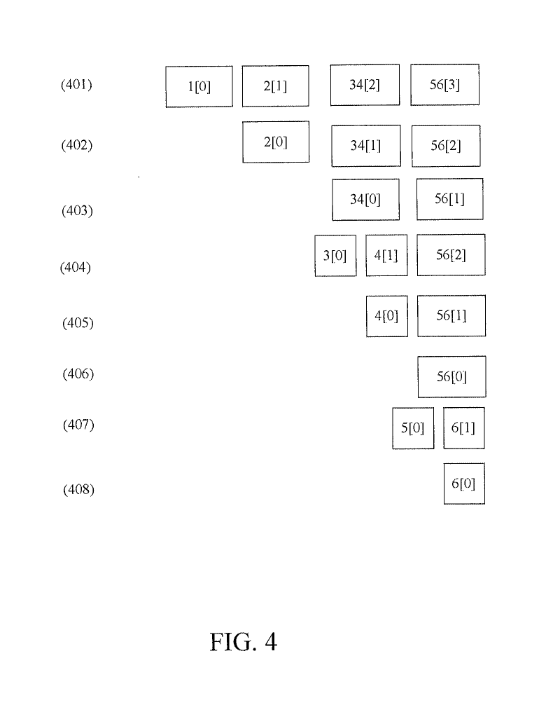

FIG. 4 is a schematic diagram of the arbitration after applying the method of the present invention, and the initial value is selected as 4 according to the pre-estimating number of the labels. The arbitration process is as follows:

(401) initialization, where each counter corresponding to the label selects a random number from 0˜3, and the counters are 012233 and to respond normally;

(402) counter 01122, normal counting;

(403) counter 0011, where the collision occurs;

(404) counter 0122, normal counting;

(405) counter 011, normal counting

(406) counter 00, where the collision occurs;

(407) counter 01, normal counting;

(408) counter 0, normal counting, where the arbitration process ends.

From the above description, it can be seen that, with the method of the present invention, the number of time slots for arbitration is reduced from 11 to 8, in which the number of time slots of collision is reduced from 5 to 2, thus reducing the probability of collision and improving the arbitration efficiency.

The present invention also provides a label anti-collision system, and the system comprises a reader and several labels; wherein,

the reader is adapted to predetermine the number of labels, send the number of the labels to the labels, and send start counting instruction;

each of the labels is adapted to initialize information of the label itself after receiving the start counting instruction, select a random number as an initial value of a counter according to the predetermined number of the labels and enter into a arbitration process.

In the above-mentioned system, the reader is also adapted to select the labels in an effective RF field area and send select instruction before the labels enter into the arbitration process;

correspondingly, the labels are adapted to perform a condition matching after receiving the select instruction, and those labels meeting the condition enter into the arbitration process.

In the above-mentioned system, the labels are adapted to respond the reader with information of the labels whose counter values are 0;

the reader is adapted to receive the information of the labels within a stated time slot, if the reader receives a correct response information from a label or does not receive any response information within the stated time slot, send a success acknowledgement instruction to the label, and if the reader receives a collision error information within the stated time slot, consider that a plurality of the labels respond and collisions happen, and send failure acknowledgement instructions to the labels.

In the above-mentioned system, the labels are adapted that, when receiving the success acknowledgement instructions, those labels whose label identifications conform to success command parameters including in the success acknowledgement instructions leave the arbitration process after responding successfully; and for those labels whose label identification do not conform to the success command parameters, the counter values of those labels are subtracted by 1, and the labels whose counter values are 0 respond to the reader;

the labels are adapted that: when the labels receive the failure acknowledgement instructions, those labels whose counter values are 0 perform to split and a random number generator is started up, and the counter values are modified according to generated random numbers; and the labels whose counter values are not 0 add the counter values by 1, and the labels whose counter values are 0 respond to the reader.

From the above description, it can be seen that, no matter it is the method or the system, the technology of the present invention can be applied to the RFID systems including the reader and the labels. When the labels enter into the arbitration process, the reader sends the predetermined number of the labels to the labels and also send the start counting instruction; after the labels receive the start counting instruction, they initialize their own information and each of the labels selects one random number as the initial value of the counter according to the predetermined number of the labels and enters into the arbitration process. Thus, at the beginning of arbitrating with the Binary Tree method, all the labels are hashed, thereby reducing the probability of collisions and improving the arbitration efficiency.

The above description is only preferred embodiments of the present invention and is not intended to limit the present invention. For those skilled in the art, it can be understood that there may be a variety of modifications and variations in the present invention. All of modifications, equivalents and/or variations without departing from the spirit and essence of the present invention should be embodied in the scope of the appending claims of the present invention.

1. A label anti-collision method, applied in a radio frequency identification system comprising labels and a reader, wherein, when the labels enter into an arbitration process, the method comprises:
the reader sending the predetermined number of labels to the labels and further sending start counting instruction;
after a label receives the start counting instruction, the label initializing its own information, according to the predetermined number of labels selecting a random number as an initial value of a counter and entering into the arbitration process.

2. The method of claim 1, wherein, before the label enters into the arbitration process, the method comprises:
the reader selecting labels in an effective radio frequency field area;
the reader sending select instruction, and after the labels receive the select instruction, the labels performing a condition matching, and when meeting the condition the labels entering into the arbitration process.

3. The method of claim 1, wherein, the arbitration process comprises:
responding the information of the labels whose counter values are 0 to the reader;
the reader receiving the information of the labels;
if the reader receives a correct response information from a label or there is no response information within a stated time slot, the reader sending a success acknowledgement instruction to the label; and if the reader receives a collision error information within the stated time slot, the reader considering that a collision happens because a plurality of labels respond, and then sending failure acknowledgement instructions to the labels.

4. The method of claim 3, wherein, when the labels receive the success acknowledgement instructions, those labels whose label identifications conform to success command parameters comprising in the success acknowledgement instructions leave the arbitration process after further responding successfully; and for those labels whose label identifications do not conform to the success command parameters, the counter values of those labels are further subtracted by 1, and then the labels whose counter values are 0 further respond to the reader.

5. The method of claim 3, wherein, when the labels receive the failure acknowledgement instructions, those labels whose counter values are 0 further perform to split and a random number generator is started up, and the counter values are modified according to generated random numbers; and the labels whose counter values are not 0 further add the counter values by 1, while the labels whose counter values are 0 further respond to the reader.

6. A label anti-collision system, comprising a reader and labels; wherein,
the reader is adapted to predetermine the number of labels, send the number of the labels to the labels, and send start counting instruction;
each of the labels is adapted to initialize information of the label itself after receiving the start counting instruction, select a random number as an initial value of a counter according to the predetermined number of the labels and enter into an arbitration process.

7. The system of claim 6, wherein, the system further comprises:
the reader is further adapted to select labels in an effective radio frequency field area and send select instruction before the labels enter into the arbitration process;
the labels are further adapted to perform a condition matching after receiving the select instruction, and the labels meeting the condition enter into the arbitration process.

8. The system of claim 6, wherein,
the labels are further adapted to respond the reader with the information of the labels whose counter values are 0;
the reader is further adapted to receive the information of the labels within a stated time slot; and if the reader receives a correct response information from a label or there is no response information within the stated time slot, send a success acknowledgement instruction to the label, and if the reader receives a collision error information within the stated time slot, consider that a collision happens because a plurality of labels respond, and send failure acknowledgement instructions to the labels.

9. The system of claim 8, wherein, the labels are further adapted that:
when receiving the success acknowledgement instructions, those labels whose label identifications conform to success command parameters comprising in the success acknowledgement instructions leave the arbitration process after responding successfully; and for those labels whose label identification do not conform to the success command parameters, the counter values of those labels are subtracted by 1, and the labels whose counter values are 0 respond to the reader.

10. The system of claim 8, wherein, the labels are further adapted that:
when the labels receive the failure acknowledgement instructions, those labels whose counter values are 0 perform to split and a random number generator is started up, and the counter values are modified according to generated random numbers; and the labels whose counter values are not 0 add the counter values by 1, while the labels whose counter values are 0 respond to the reader.

11. The method of claim 2, wherein, the arbitration process comprises:
responding the information of the labels whose counter values are 0 to the reader;
the reader receiving the information of the labels;
if the reader receives a correct response information from a label or there is no response information within a stated time slot, the reader sending a success acknowledgement instruction to the label; and if the reader receives a collision error information within the stated time slot, the reader considering that a collision happens because a plurality of labels respond, and then sending failure acknowledgement instructions to the labels.

12. The method of claim 11, wherein, when the labels receive the success acknowledgement instructions, those labels whose label identifications conform to success command parameters comprising in the success acknowledgement instructions leave the arbitration process after further responding successfully; and for those labels whose label identifications do not conform to the success command parameters, the counter values of those labels are further subtracted by 1, and then the labels whose counter values are 0 further respond to the reader.

13. The method of claim 11, wherein, when the labels receive the failure acknowledgement instructions, those labels whose counter values are 0 further perform to split and a random number generator is started up, and the counter values are modified according to generated random numbers; and the labels whose counter values are not 0 further add the counter values by 1, while the labels whose counter values are 0 further respond to the reader.

14. The system of claim 7, wherein,
the labels are further adapted to respond the reader with the information of the labels whose counter values are 0;
the reader is further adapted to receive the information of the labels within a stated time slot; and if the reader receives a correct response information from a label or there is no response information within the stated time slot, send a success acknowledgement instruction to the label, and if the reader receives a collision error information within the stated time slot, consider that a collision happens because a plurality of labels respond, and send failure acknowledgement instructions to the labels.

15. The system of claim 14, wherein, the labels are further adapted that:
when receiving the success acknowledgement instructions, those labels whose label identifications conform to success command parameters comprising in the success acknowledgement instructions leave the arbitration process after responding successfully; and for those labels whose label identification do not conform to the success command parameters, the counter values of those labels are subtracted by 1, and the labels whose counter values are 0 respond to the reader.

16. The system of claim 14, wherein, the labels are further adapted that:
when the labels receive the failure acknowledgement instructions, those labels whose counter values are 0 perform to split and a random number generator is started up, and the counter values are modified according to generated random numbers; and the labels whose counter values are not 0 add the counter values by 1, while the labels whose counter values are 0 respond to the reader.
